(19) United States
(12) Patent Application Publication
(10) Pub. No.: US 2008/0003889 A1
(43) Pub. Date: Jan. 3, 2008

(54) Modular I/O connector

(76) Inventor: Michael A. Link, Cornelius, OR (US)

Correspondence Address: INTEL CORPORATION;c/o INTELLEVATE, LLC, P.O. BOX 52050, MINNEAPOLIS, MN, 55402, US

(21) Appl. No.: 11/479,591

(22) Filed: Jun. 30, 2006

(51) Int. Cl. H01R 13/514

(52) U.S. Cl. 439/701

(57) ABSTRACT

A modular I/O connector, comprising a housing, at least one cavity in the housing, the cavity having at least one opening to the exterior of the housing, at least one electrically conductive member within the cavity, the electrically conductive member electrically coupled with an electrically conductive pathway, and at least one coupling member to physically couple with another connector.

### FIELD OF THE INVENTION

The invention relates generally to the field of input/output (I/O) connectors for electronic systems. In particular, the invention relates to modular I/O connectors.

### BACKGROUND OF THE INVENTION

Electronic systems, such as computer systems, employ numerous I/O connectors integrated onto printed circuit boards (PCBs) in the design and assembly of motherboards. I/O connectors are presented to the system exterior to allow for plugging various peripheral devices into the connectors. The connectors are assembled directly to a PCB, usually by a solder material, during motherboard assembly, and the number and types of connectors on the motherboard become relatively permanent at that stage. Many systems include stacked connectors with multiple ports, affixed to a motherboard in a single, unified footprint, to conserve motherboard space or to conform to standard form factors (e.g., ATX). These stacked connectors are relatively expensive and add cost to the motherboard, and their use assumes that the technologies supported by the connector are populated on the PCB at the time the motherboard is manufactured. However, for numerous technologies, this is not the case.

It can be too expensive, or otherwise prohibitive, to integrate some technologies, such as wireless, directly on the motherboard, due to requirements for regulatory certification or other reasons. While these technologies could be integrated into mezzanine, PCI, or other add-in cards, and added to a system after system assembly, there are limitations and problems with this approach. Typically, these options have been limited to PCI cards because other card types may not have access to the system exterior to, for example, connect an external antenna to an internal radio device. To accommodate technologies implemented in ways that would otherwise preclude direct external access, extensive disassembly/re-assembly of the system may be required, putting this approach outside the skill level of many users, and carrying a strong risk of damage to the system. Therefore, in many cases, an entire motherboard must be initially designed and manufactured with the technology solution and the corresponding I/O connectors integrated onto the motherboard, in order for a customer to obtain a system including those technologies.

Further, it may be difficult to integrate new technologies, and the corresponding external connectors, into standardized motherboard form factors not originally designed to accommodate those connector types. For example, most motherboards for desktop and server systems in the computer industry are built according to standardized form factors. Adding a new connector type on the motherboard requires altering or violating a specification that is already deeply engrained in the computer industry, or creating an entirely new specification. This is a slow and inflexible process, limiting manufacturers' ability to rapidly assimilate new technologies into their product offerings to customers. Because new technologies move into the marketplace at a faster rate than motherboard standards are updated or created, consumer demand for new technologies imposes numerous design inefficiencies and conflicting priorities on system manufacturers.

### BRIEF DESCRIPTION OF THE DRAWINGS

FIG. 1a depicts an oblique rear/side view of an embodiment of a modular I/O connector and a base connector, and the corresponding coupling members of each connector.

FIG. 1b depicts an oblique side/rear view of an embodiment of an I/O connector assembly including a modular I/O connector coupled with a base connector, including the coupled coupling members of each connector.

FIG. 1c depicts an oblique front/side view of an embodiment of an I/O connector assembly including a modular I/O connector coupled with a base connector.

FIG. 2 depicts a side view of an embodiment of a modular I/O connector including a captive cable.

FIG. 3a depicts a frontal view of an embodiment of a modular I/O connector and a base connector including coupling members configured for coupling the connectors in a lateral position with respect to each other.

FIG. 3b depicts a frontal view of an embodiment of an I/O connector assembly including a modular I/O connector and a base connector coupled in a lateral position with respect to each other.

FIG. 4a depicts an oblique side/rear view of an embodiment of a base connector configured with coupling members formed as channels and a modular I/O connector configured with corresponding coupling members.

FIG. 4b depicts an oblique side/rear view of an embodiment of an I/O connector assembly including a base connector configured with assisting coupling members and coupling members formed as channels, coupled with a modular I/O connector configured with corresponding coupling members

FIG. 5a and 5b depict a side view of an embodiment of a modular I/O connector configured to couple with a bracket affixed to a printed circuit board.

FIG. 6 depicts a cross-sectional view of a portion of a computer system including a modular I/O connector according to an embodiment of the invention.

### DETAILED DESCRIPTION OF THE INVENTION

Embodiments of the invention include a ‘modular connector’, which is a connector configured for addition to a system (e.g., computer system) during or after system assembly, and therefore is not attached directly to a PCB by a solder material. Rather, in numerous embodiments, a modular connector is physically coupled with another apparatus, device, or assembly, which is in turn coupled to the PCB. In some embodiments, however, a modular connector is subsequently coupled with the PCB of an already assembled card or motherboard (e.g., a printed circuit board to which a plurality of electronic components has already been attached during a motherboard assembly process). In numerous embodiments, a modular connector coupled with another apparatus, device, or assembly can also be decoupled manually or with the aid of a tool. A modular connector may electrically couple with a PCB or a signal processing component through the other apparatus, device, or assembly to which it is physically coupled, or by an electrically conductive pathway (e.g., cable) coupled with and between the modular connector and the PCB or other component.

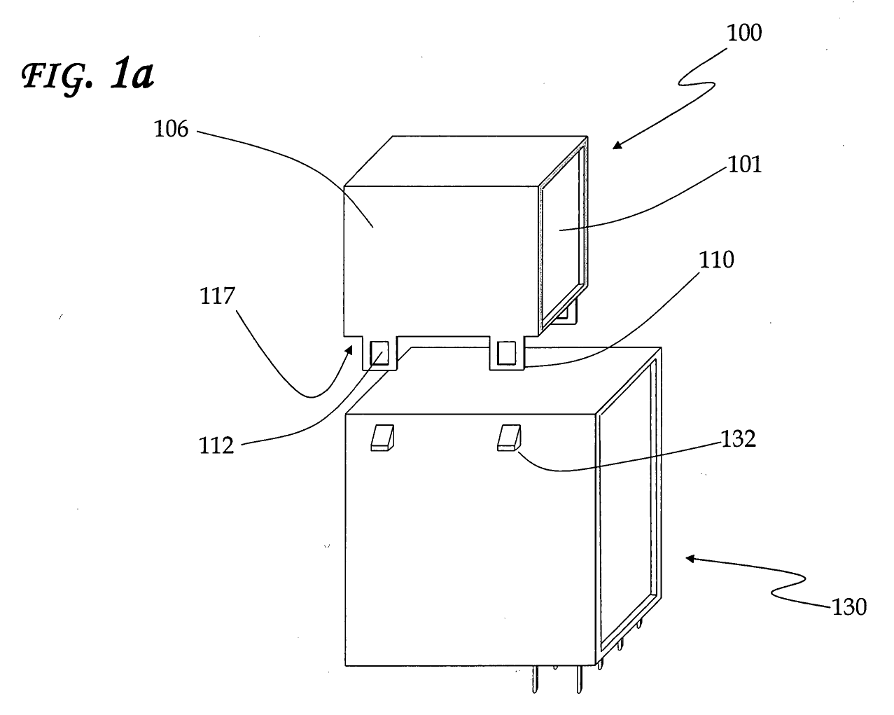

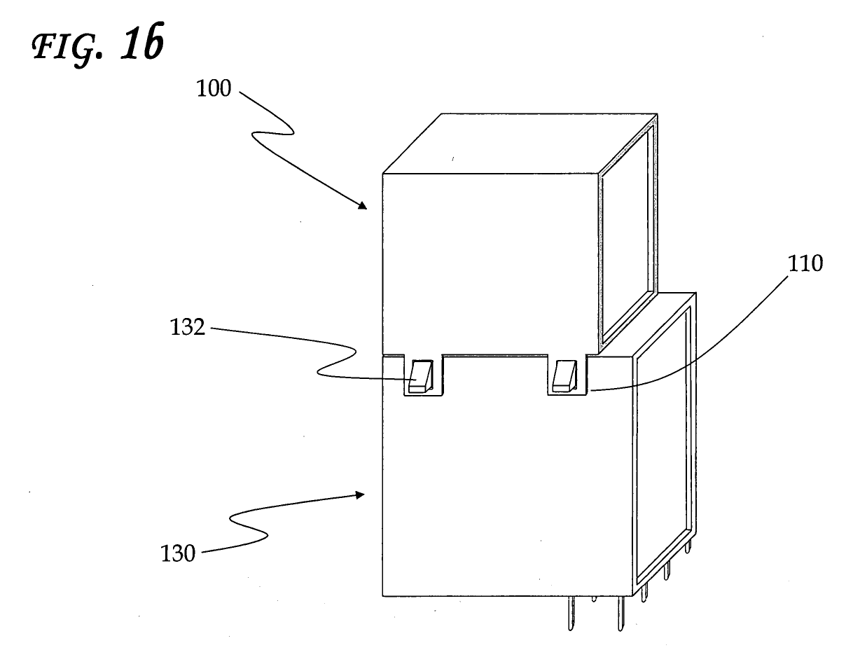

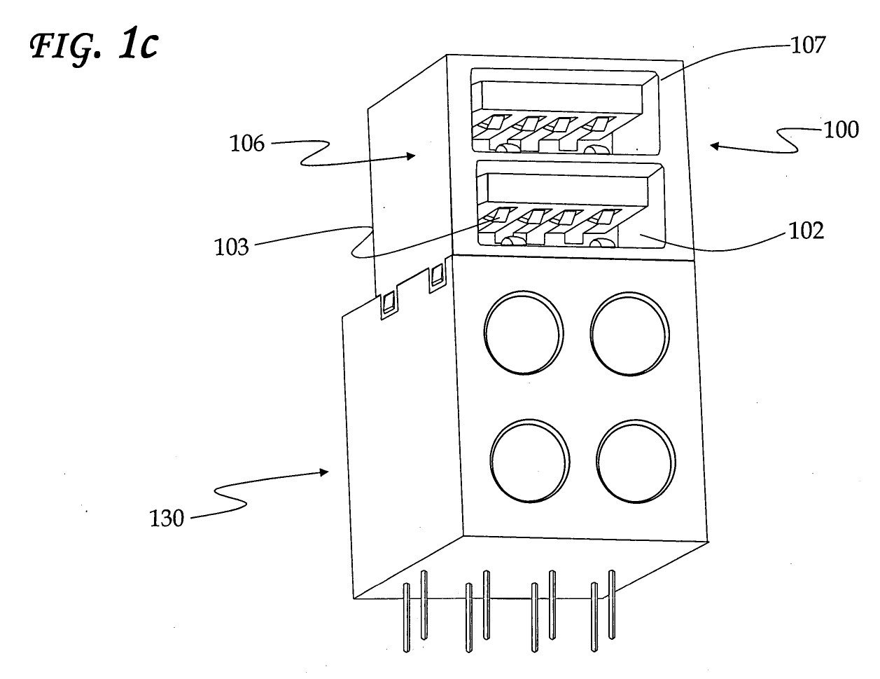

With reference to FIG. 1a, embodiments of a modular connector 100, such as an I/O (input/output) connector, include a housing portion 101 (‘housing’). The housing 101 may be formed of a single integral piece, or in other embodiments, it may be formed by assembling two or more pieces together. Each piece is typically formed of injection molded plastic materials, however, in alternative embodiments, other electrically insulating materials are used, such as ceramics, or plastic materials formed by methods other than injection molding. In embodiments, the materials comprising the housing 101 are colored (e.g., as conforming with the PC99 standards) to provide a visual reference to aid users when connecting peripheral devices to the connector 100, while others may be black, white, or ‘putty’ colored, similar to the common colors of many computer chassis.

A housing 101 will, as in the embodiment depicted in FIG. 1c, have one or more cavities 102 formed therein, each cavity 102 also configured with an opening to the exterior of the housing 101. Each cavity 102 is configured as a receptacle, or ‘port’, to enable receiving and/or retaining at least a portion of an inserted complimentary I/O terminal ‘interconnect member’ (e.g., plug). Therefore, the internal dimensions of a cavity 102 will permit entry of a portion of a corresponding interconnect member into the cavity, and in many respects, may also conform closely to the outer dimensions of that portion of the interconnect member that is to be inserted into the cavity 102. Modular connector housings 101, according to embodiments of the invention, are capable of being formed with cavities 102 to accommodate nearly any type of interconnect member, as defined by various I/O technologies. While exemplary embodiments of interconnect members include those configured as USB, 1394, S-video, RCA, 9 mm audio, and coaxial plugs, the embodiments are not so limited in scope. Modular connector housings 101 can likewise be formed with cavities 102 to accommodate a plurality of a specific type of interconnect member, or to accommodate a plurality of types of interconnect members. For example, one modular connector 100 may accommodate two USB interconnect members, while another accommodates one USB and one 9 mm audio plug, and a third accommodates a 9 mm audio plug and an S-video plug, although the embodiments are not limited to only these examples.

Within the cavity 102, in embodiments, will be at least one electrically conductive member 103, or ‘contact’. For example, a modular connector configured for USB will have at least one contact 103 in the cavity 102 as depicted in FIG. 1c. In embodiments, an electrically conductive member 103 of a modular connector 100 is configured to electrically couple with a corresponding electrical contact of an interconnect member when the interconnect member is inserted into the cavity 102. Therefore, an electrical signal conducted along, for example, a coaxial signal transmission cable, will pass from an electrical contact of the coaxial interconnect member to a corresponding electrical contact 103 of the modular connector 100, and vise versa. The electrical contact 103 of the modular connector 100 may be, in embodiments, electrically coupled with an electrically conductive pathway capable of conducting an electrical signal from the contact 103 to another portion of the connector, or to another component. In embodiments, a conductive pathway located primarily or entirely within the housing of a modular connector conducts an electrical signal from an electrical contact 103 in a cavity 102 at one side of a modular connector 100 to a second conductive contact in a second cavity located at another side of the connector. In such embodiments, where the first contact and the second contact are both part of a single integrated conductive member, the portion of the conductive member located between the first and second contact portions is considered an electrically conductive pathway. A plug of a cable can be inserted into the second cavity to conduct the signal from the modular connector to a component located separately from the modular connector.

In another embodiment, the electrical contact 103 in the cavity 102 is electrically coupled with an electrically conductive member (contact) disposed at a coupling surface 117 (i.e., surface of a modular connector which is held closely adjacent to the surface of another connector, a bracket, and printed circuit board, or a component, when physically coupled) of the modular connector. The conductive member is configured to electrically couple with an electrical conductive member (contact) of at least one of another connector (e.g., base connector), a bracket, a PCB, or a component, with which the modular connector is physically coupled. In the embodiments including another connector, a bracket, or a component, an electrically conductive pathway of the other connector, bracket, or component then conducts an electrical signal from the electrical contact 103 of the modular connector 100 to an electrical pathway of a substrate with which the other connector, bracket, or component is electrically coupled. An electrically conductive member (contact) disposed at a surface of a connector includes those contacts disposed at a plane of the surface, as well as those disposed at least partially above or below the surface plane, but accessible for electrically coupling with the reciprocal electrical contacts of another connector.

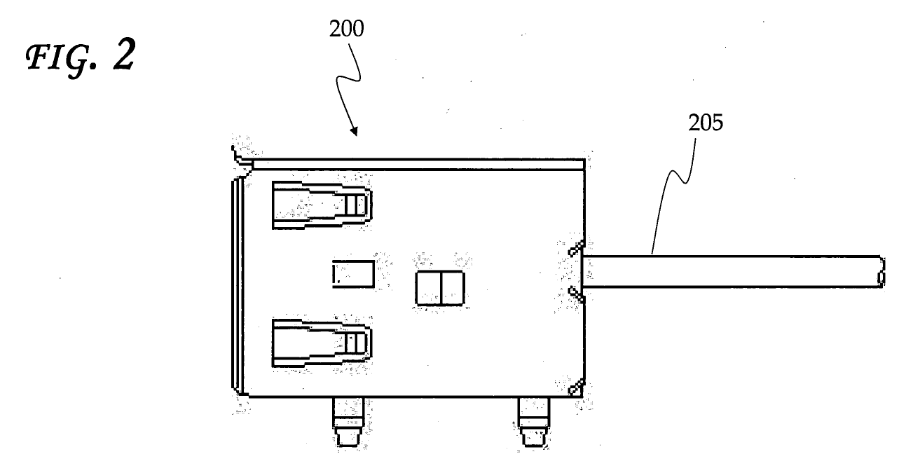

In still another embodiment depicted in FIG. 2, a conductive pathway comprises a portion of a captive cable 205 (e.g., coaxial cable) affixed to the modular connector 200, and conducts an electrical signal from an electrical contact 103 in a cavity 102 at one side of a modular connector 200 to a component located separately from the modular connector 200. As described herein, a contact ‘within a cavity’ includes any contact so positioned as to be presented to the interior of a cavity 102, enabling an electrical contact of a portion of an interconnect member inserted into the cavity 102 to electrically couple with the electrical contact 103 of the modular connector 200.

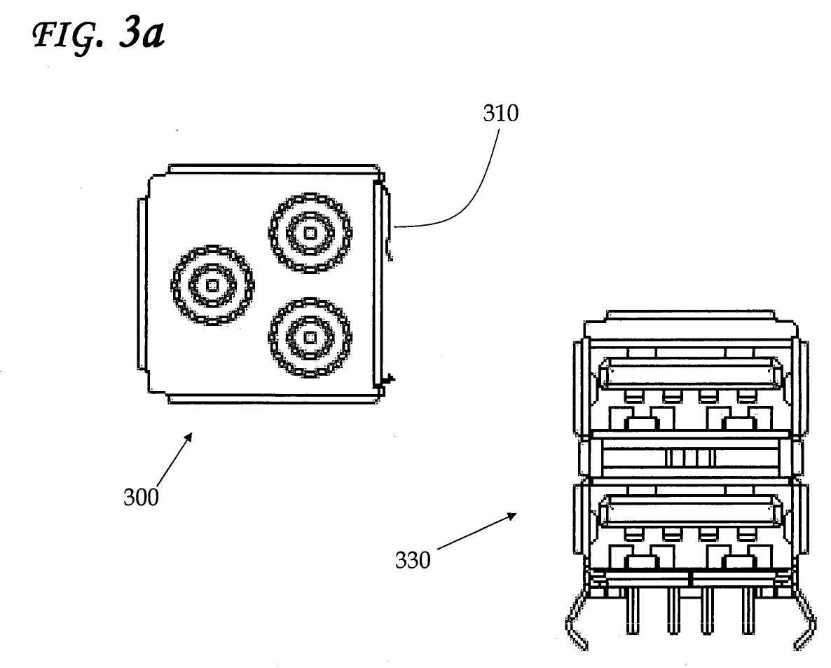

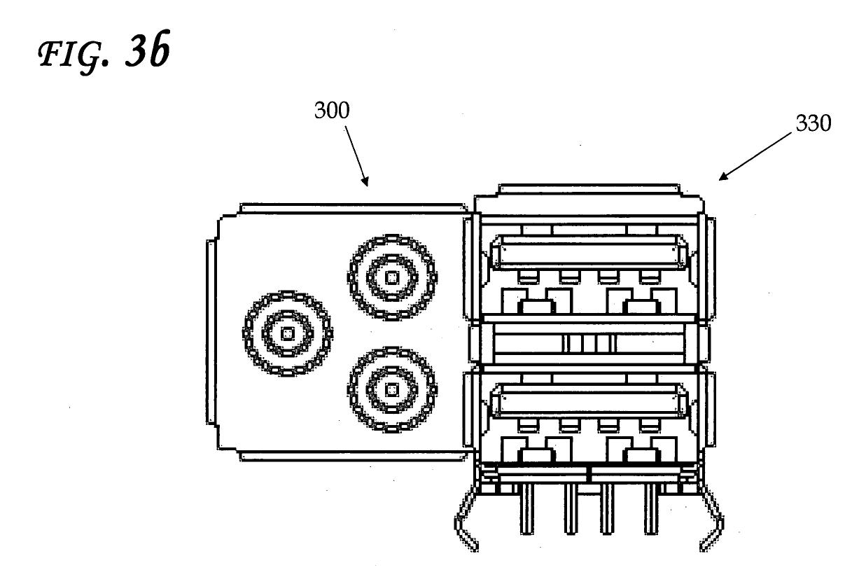

Typically, a shield 106 at least partially surrounds the housing 101, although the embodiments are not so limited. In an embodiment, the shield 106 comprises stamped and formed sheet metal, configured to conform in many respects to the external dimensions and shape of the housing 101. A metal shield 101 provides benefits by containing and/or excluding electromagnetic interference (EMI), and may be referenced to as an EMI shield. A shield 101 will have an opening 107 corresponding to the opening to a cavity 102 of the housing 101, so that the shield 106 does not occlude access to the cavity 102 for inserting an interconnect member into the cavity 102. With respect to embodiments of the shield of a modular connector 100 configured to be attached to a base connector 130, portions of the shield 106 are formed as coupling members 110 to couple the modular I/O connector 100 with coupling members 132 of the base connector 130. These coupling members 110 are also formed, in alternate embodiments, to project from the ‘top’ of the base connector 130, so that a modular connector 100 can be coupled at the top of the base connector 130 to form a somewhat vertical connector stack. In embodiments possessing this configuration, the modular connector 100 is coupled with the opposing side of the base connector 130 from where the base connector 130 is coupled with a substrate. In other embodiments depicted in FIG. 3a and 3b, the coupling members 310 project at least in part laterally from either the base connector 330 or the modular connector 300, or both, so that a modular connector 300 can be coupled either alongside the base connector 330, or coupled with the back side of a base connector. In the latter embodiment, the opening for receiving an external interconnect (plug) may be presented either to the back panel of a system, as the openings of the base connector may be, or to another panel, such as a side panel or top panel.

In the described embodiments of a modular connector with coupling members projecting from the shield of the modular connector, coupling of the modular connector with a base connector may be achieved by any one of, or any combination of, numerous approaches. In embodiments, the coupling members of the base connector are spring loaded members that are deflected by coupling members of the modular connectors, and achieve secure coupling of the connectors through a clamping force exerted by the coupling members of the base connector upon the coupling members of the modular connector. In other embodiments, a coupling member of a base connector inserts into corresponding receptacle (also a type of coupling member) of the modular connector, and is retained within the receptacle through a mechanical coupling (e.g., spring force, hook, friction fit). In still other embodiments, such as that depicted in FIG. 1a and 1b, the coupling members 110 are spring loaded, and are formed with at least one opening 112 or hook-like feature, so that the coupling members 110 are initially deflected by coupling members 132 of the modular connector 130, and then relax, capturing the coupling members 132 within the opening 112 or hook-like feature. In such embodiments, the continuous exertion of a spring force is not required to retain a close and durable coupling of a modular connector 100 with a base connector 130.

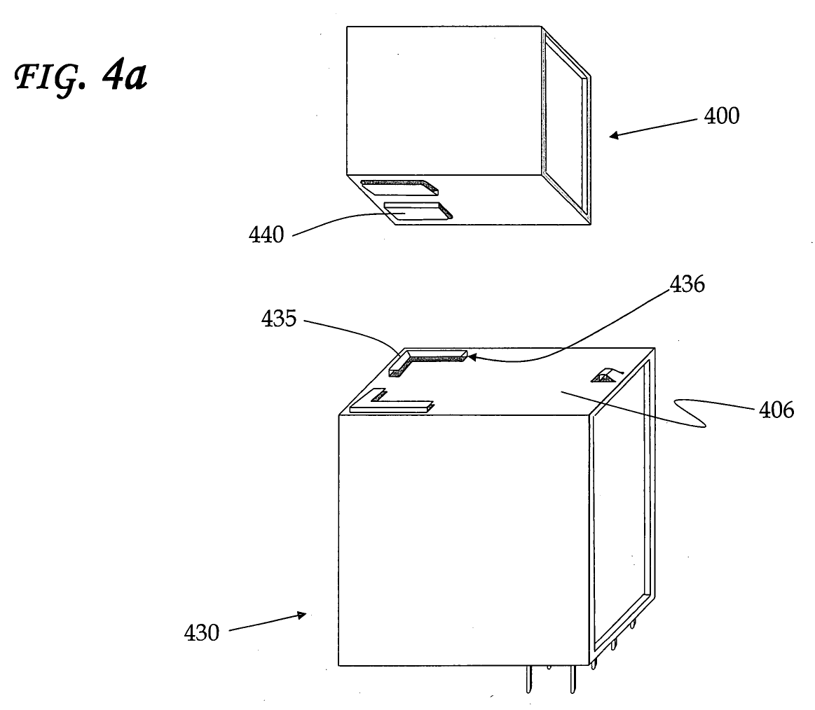

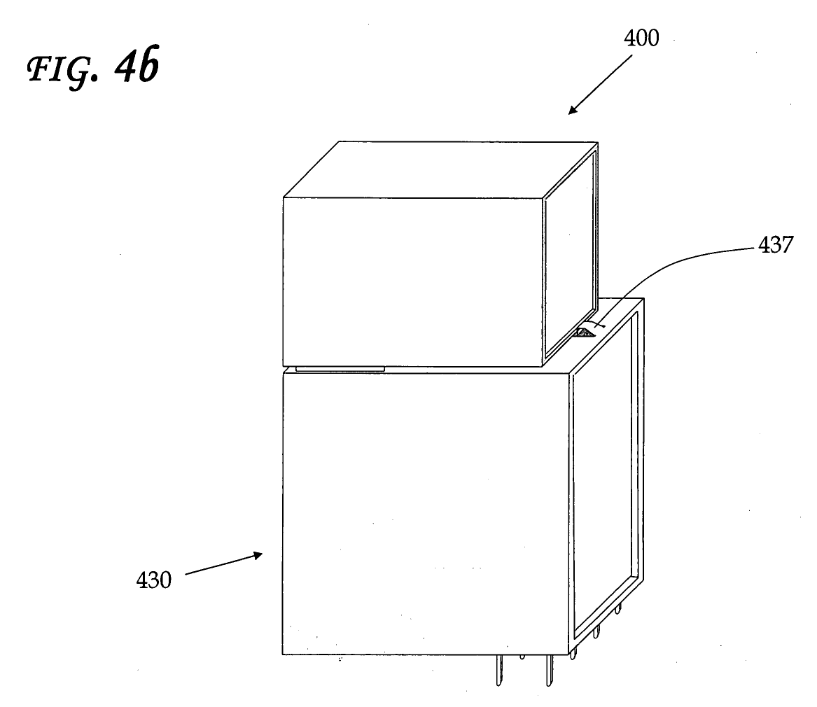

In still another embodiment depicted in FIGS. 4a and 4b, a coupling member 435 forms a channel 436 between a portion of the coupling member 435 and the shield 406 or housing of the base connector 430, and a reciprocal portion 440 (e.g., a groove, fin, notch, row of projections) of the modular connector 400 is received into this channel 436. In one such embodiment, two or more coupling members 435 of a connector form opposing channels 436 which capture reciprocal portions 440 of another connector as the reciprocal portions 440 slide into and along the channels 436. The channels 436 of a connector may sufficiently retain another connector, while in embodiments, another coupling member 437 assists in maintaining a durable coupling between a base connector 430 and a modular connector 400. In an embodiment, the assisting coupling member 437 actuates as a result of the sliding motion of reciprocal portion(s) 440 of one connector relative to the channels 436 of another, and fully engages as the final coupled position of the connectors relative to each other is attained, preventing the modular connector 400 from dislocating and/or decoupling from the base connector 430. In a related embodiment, while the coupling surfaces of the modular and base connectors are held at an angle to one another, a reciprocal portion 440 of the modular connector is engaged with a channel portion 436 of the base connector. While maintaining this engagement, the modular connector is rotated about an axis centered approximately at the reciprocal portion 440 so that the planes of the coupling surfaces are brought into a position parallel with respect to each other. In doing so, a spring loaded coupling member on either the modular or the base connector deflects under pressure from, and engages with, a coupling member on the other of the modular or base connector feature, durably coupling the connectors together.

In still another embodiment, while holding the connectors so that the planes of their respective coupling surfaces are held approximately parallel with each other, and the rotational orientation of the connectors relative to one another, about an axis passing through both connectors, is something other than the final assembled orientation, moving the connectors toward one another causes the coupling member(s) of a modular connector to interface with a reciprocal member of the base connector. When the coupling member of the modular connector and the reciprocal coupling member of the base connector interface, the modular connector is rotated relative to the base connector about the axis passing through both connectors and centered within the projecting and reciprocal coupling members. As a result of such rotation, portions of the coupling member and of the reciprocal member interlock, durably coupling the connectors together.

In alternate embodiments, a modular connector and a base connector are physically coupled by one of a threaded fastener (e.g., screw, bolt), a friction fitting fastener, a rivet, or another conventional fastening device. Such fastening devices may be formed as a part of one of the modular or base connector, or may comprise a separate member inserted into, through, or around a portion of one or both connectors, coupling the connectors together.

In other embodiments, an adhesive material durably couples a modular connector with a base connector when the coupling surfaces of connectors are placed closely adjacent to one another, each being in contact with the interceding adhesive material. Adhesive materials may include epoxy resins, ‘peel and stick’ adhesive pads, thermoplastic or thermosetting adhesives, cyanoacrylate-based adhesive materials (e.g., methyl-2-cyanoacrylate, 2-octyl cyanoacrylate), and/or others capable of forming a durable bond between surfaces of the modular connector housing or shield, and the base connector housing or shield. In embodiments, a disposed adhesive material is also considered a ‘coupling member’.

In the described embodiments, while coupling members are frequently described as projecting from the one of the base connector or the modular connector, the embodiments are not so limited. Coupling members may project from the modular connector only, from the base connector only, or may project from both the modular and the base connector, interacting with reciprocal coupling members on the other connector. The reciprocal coupling members may likewise reside on either one or both of the connectors, according to alternative embodiments. Further, although the coupling members described in the above embodiments are formed as portions of the shields of a modular and/or base connector, such members may also be formed as portions of the housing of a modular or base connector. In such embodiments, the shield is formed with openings corresponding to coupling members of the connector housing so as not to impede their function. In yet other embodiments, a coupling member formed from the housing of one connector may interact with a coupling member formed from the shield of another connector. Therefore, the described embodiments of a modular I/O connector encompass a large amount of design variability and functional alternatives. Because a modular connector may couple with a bracket, component, a structural member of a system, or a printed circuit board (PCB) in embodiments, rather than with another connector, at least one of the coupling members described in this specification will also be provided on a bracket, component, system structural member or PCB configured to couple with a modular connector.

In further embodiments, a modular connector and a base connector are durably attached, one to another, with a clip or a plurality of clips that engage with coupling members formed as portions of either the shield or housing of one or both of the connectors. In an exemplary embodiment, a clip has two ends, each of which engages with a coupling member of a base connector, holding the ends in a fixed position. The portion of the clip between the two ends traverses up from each coupling member and over or through a portion of the modular connector. The portion of the clip positioned over or through the modular connector comprises a spring which exerts a downward force upon the modular connector, durably retaining the modular connector in position relative to the base connector. Alignment features may also be formed to project outward from the modular connector, retaining a portion of the clip in a position relative to a limited portion of the surface of the modular connector, helping to prevent either the modular connector or the clip from slipping out of position, one with respect to the other. In still another embodiment, a clip configured to durably couple a modular connector in close proximity with a base connector will physically couple with at least one coupling member that is durably coupled with a substrate. In alternate embodiments, the coupling member is coupled with the substrate by a solder material, is retained at least partially within an orifice formed in the substrate, or may constitute a physical feature of the substrate itself. In embodiments, a clip is also considered a ‘coupling member’.

In still further embodiments, the shield of a base connecter extends beyond the outer dimensions of the base connector housing(s). The extended portion of the base connector shield has an opening formed into one side, allowing a modular connector housing to be inserted through the opening and retained within the shield of the base connector. The base connector shield also has an opening formed in another side corresponding to the opening of a cavity of the modular connector housing, so as not to occlude the opening of the modular connector housing. Therefore, according to such embodiments, the modular connector generally will not have a shield separate from the base connector, but will share a single, unitary shield with the base connector, although in some embodiments, the modular connector may also have a shield independent from the base connector shield. In alternative embodiments, coupling members on the modular connector housing and either the base connector housing, the unitary shield, or both, interlock to durably retain the modular connector housing in position relative to the shield and/or the base connector housing(s). The modular connector housing and the base connector housing and/or the base connector shield will also, in embodiments, be formed with corresponding features to guide and align the modular connector housing as it slides into the base connector shield, to minimize mis-alignments, binding, and/or damage to the housings or shield(s) during insertion. Such guide/alignment features may also be configured to retain the modular connector housing in its fully inserted position.

In a similar embodiment, rather than corresponding and reciprocal coupling members being formed as part of the modular connector housing or the shield, the shield is formed with deformable members that may be bent into an obstructive position after insertion of the modular connector housing into the shield. When bent into an obstructive position, the deformable members obstruct the path of the modular connector housing so that it cannot slide out along the path that it entered into the shield, and the modular connector housing is therefore securely retained in the shield by the deformable members. In a similar embodiment, deformable members are formed into the shield and bent into the insertion path of the modular connector housing so that when the housing is inserted into the shield, the deformable members are deflected outward by the housing. Each deformable member will have some amount of spring tension when deflected, so that some amount of pressure is exerted against the side of the modular connector housing by the deflected deformable member. A groove, notch, ridge, or other feature may be formed into a side of the modular connector housing into which, or behind which, the terminal end of each deformable member lodges when the modular connector housing is fully inserted. Thus, when pressure is applied to the modular connector housing, such as when an interconnect member is forcefully inserted into a cavity of the connector, the deformable member prevents dislocation of the modular connector housing. In embodiments wherein such features are absent from a side of the housing, friction of the deflected deformable members against a side of the modular connector housing will resist housing dislocation. It should be appreciated that greater friction, and therefore greater resistance to housing dislocation, is achieved in embodiments of a modular housing wherein the housing material is soft enough to allow slight penetration into the material surface by the deformable members. Likewise, deformable members formed to be pointed or roughened where they contact an inserted modular connector housing will provide higher friction, and therefore increased resistance to housing dislocation.

Similar to the various embodiments described above, in embodiments wherein the modular connector housing also has an independent shield, and the housing is inserted into an extended portion of the base connector shield configured to receive the modular housing, coupling members formed into the modular connector shield may also correspond to and interact with coupling members formed into the base connector shield or housing, retaining and resisting dislocation of the modular connector.

In various exemplary embodiments described above, a modular connector is described as coupled with a base connector in an arrangement wherein the base connector is positioned below (e.g., closer to a substrate than) the modular connector. The embodiments, however, are not so limited in scope. For example, most or all of the above embodiments of coupling members can be also employed in an arrangement wherein the modular and base connectors are laterally positioned with respect to each other, so that a plane bisecting both connector housings lies substantially parallel to the plane of a substrate with which the base connector is coupled, as seen in the embodiment depicted in FIG. 3b. With regard to embodiments of a base connector having an extended shield into which a modular connector is inserted, the extended shield portion for receiving the modular connector housing may also lie closer to a substrate than the base connector housing (e.g., below the base connector housing), beside the base connector housing, or between a first base connector housing and a second base connector housing positioned within the single base connector shield.

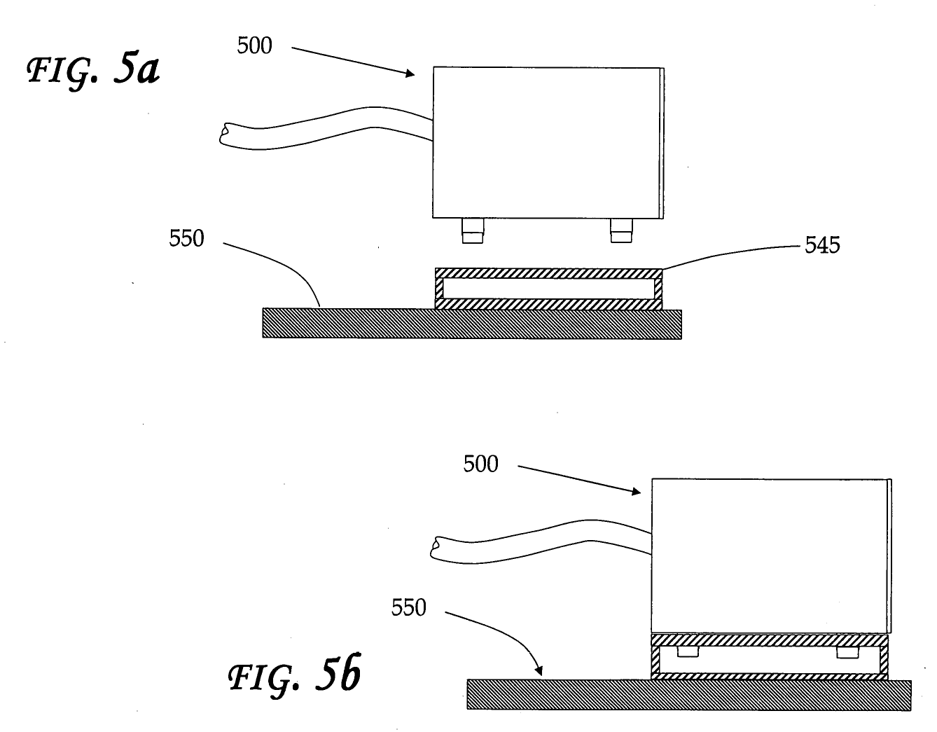

Additionally, a modular connector need not couple with a single base connector in all embodiments. For example, in an exemplary embodiment, a modular connector couples with more than one base connector. In other embodiments, a modular connector couples with another modular connector, or couples with a base connector and with another modular connector. In still other embodiments, a modular connector 500 couples with a substrate, or as depicted in FIGS. 5a and 5b, with a mounting bracket 545 that is in turn coupled with the substrate 550, without an intervening base connector. In other embodiments, a bracket is not coupled directly with a substrate, but is coupled to another connector, component, or a structural member of a system (e.g., chassis, back panel, strut, chassis cover), and a modular connector is coupled with the bracket. A mounting bracket 545 can be configured to include any one or any combination of coupling members as described above with regard to modular connectors 500 coupling with base connectors. A modular connector can also couple with another type of component when the component is coupled with a substrate and adapted to securely retain a modular connector, such as with coupling members or adhesive materials. In each embodiment of a modular connector coupled with another connector, component, bracket or substrate, the resulting assembly is considered an I/O connector assembly including a modular connector.

In most embodiments, a modular connector is added to a system during system assembly. For example, a system according to numerous embodiments is a desktop or server computer system comprising a chassis, a printed circuit board (PCB), a plurality of components (e.g., memory, logic, thermal, power management, signal processing, and other components), and a plurality of I/O connectors. Many of the plurality of components will be durably attached to the PCB to form a ‘motherboard’ during a motherboard assembly process. However, one or more additional connectors, modular connectors, may be coupled with the I/O connectors of the motherboard during assembly of a computer system. This provides computer system manufacturers with the flexibility to, using standardized motherboards, produce systems configured with greater or lesser numbers of I/O connectors, according to consumer demand or other considerations. This flexibility obviates the need to purchase, stock, and build systems with as many different custom motherboards as they wish to assemble custom computer assembly configurations, enabling substantial efficiency and cost savings. A computer system that does not include, for example, a wireless radio card and a connector to support connection of an external antenna to the radio card, can be build and sold to customers who will not need, and do not want to pay for those items. However, for customers who do want those items, the very same computer system can be built, and those items can be added at the assembly step, according to embodiments of the invention.

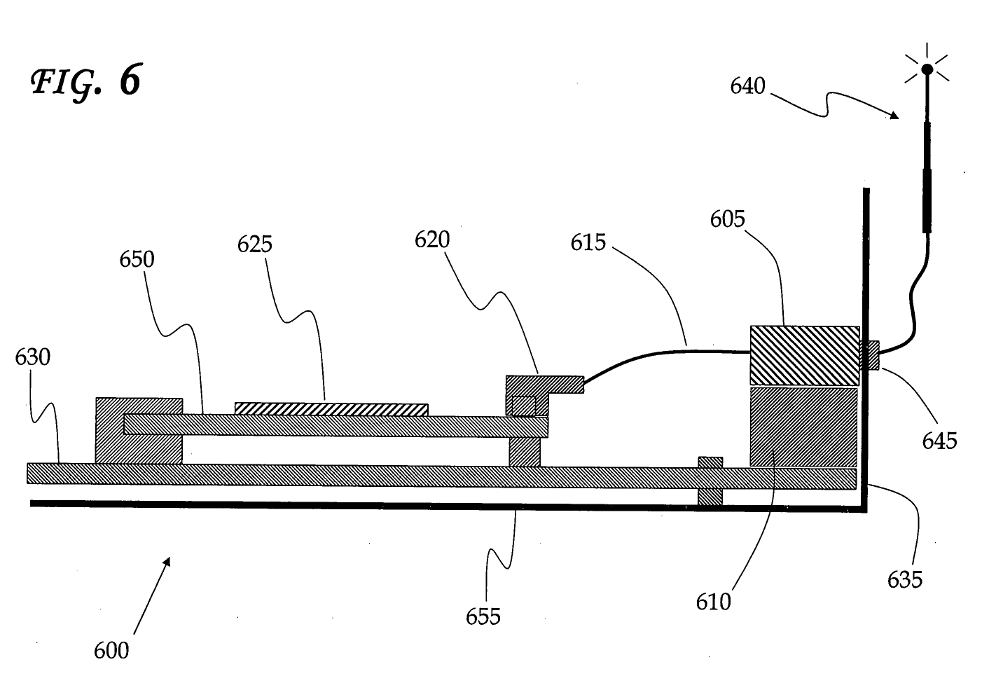

An embodiment of a computer system 600 depicted in FIG. 6 includes a modular connector 605 coupled with a base connector 610, the base connector coupled with a PCB 630, and a conductive pathway 615 for conducting an electrical signal from the modular connector 605 to a ‘target device’. The target device is a component 625, assembly, and/or connector 620 located separately on a motherboard or elsewhere in a system 600, and is configured to send a signal and/or operate upon a received signal. The PCB 630 is coupled with a system structural member 655. In an exemplary embodiment, an external antenna 640 couples with a modular connector 605 by a plug 645, and conveys a received wireless signal to the modular connector 605. The modular connector 605 conveys the signal to a conductive pathway 615 also electrically coupled with a target device 625, for example, a radio device, which then operates on the received signal to produce a result. The target device may be coupled with the computer assembly ‘up’, for example, as a PCI, mezzanine, or other card 650, or it may be placed ‘down’, integrated onto the motherboard. In each situation, a signal may be conveyed from the modular connector 605 to a target device, and/or from the target device to the modular connector 605 via a conductive pathway 615.

In embodiments, the conductive pathway 615 is a separate, detachable cable with an interconnect member (e.g., plug) formed at each end, so that one interconnect member is inserted into a cavity in the modular I/O connector 605 (the cavity being exposed to the interior of the system), and the other interconnect member is electrically coupled with either the target device 625 or with a connector 620 that is coupled with the target device 625 or with the PCB 630. Each interconnect member has an electrically conductive contact which electrically couples with a corresponding electrical contact of either the modular connector 605 or another connector 620 or the target device 625. In another embodiment, as described earlier, the modular connector 605 is formed with a captive cable affixed thereto, the cable electrically coupled with an electrically conductive contact of a cavity formed into the modular connector housing. The end of the cable opposite the modular connector has an interconnect member capable of electrically coupling with another connector or with the target device as described above. In still another embodiment, the target device is configured with a captive (e.g., permanently affixed, hard-wired) electrically conductive pathway (e.g., a cable). An end of the electrically conductive pathway is configured with an interconnect member (e.g., plug) capable of being inserted into a cavity of a modular connector, and an electrical contact capable of electrically coupling with an electrical contact of the modular connector. In each of the above examples of an electrically conductive pathway between a modular connector and a target device, the pathway may be capable of either unidirectional or bi-directional signal conveyance.

In addition to computer systems, embodiments of the invention include audio and/or graphic systems with modular connectors coupled therein. Exemplary embodiments include CD and/or DVD players, digital video recorders, or other electronic entertainment systems. Additional embodiments include test equipment systems with modular connectors coupled therein, the modular connectors modifying the test equipment systems to accommodate additional test probes, sensors, or other input sources. A cavity of a modular connector 605 coupled within a computer or other system 600, and configured to accommodate an inserted interconnect member 645, will typically correspond with an opening in the chassis or back panel 635 of the computer system, so that the interconnect member 645 can pass through the opening in the back panel 645 and enter the cavity. A system may also be configured with a perforated portion of the chassis that can be easily removed to create an opening corresponding to an added modular connector, obviating the need to provide numerous openings in the chassis or back panel that may otherwise remain unused if no modular connectors are added to correspond to those openings. Although embodiments described herein typically refer to the cavities (openings) of a modular connector and/or a base connector presenting to the back panel of a system, the embodiments are not so limited, and will, in other embodiments, present for connection to other exterior surfaces or portions (e.g., front, sides, top) of a system.

Computer and other systems are typically specified to be able to withstand threshold (minimum) levels of shock and vibration, to ensure system integrity through shipping and use. Therefore, the coupling members securing a modular connector according to embodiments of the invention will likewise be able to withstand similar levels of shock and/or vibration without being dislocated. In other embodiments, however, where a modular connector will not potentially be subjected to shock and/vibration, or where no such requirements apply, a less robust coupling mechanism can be used.

Embodiments of the invention provide numerous advantages to computer system manufacturers and users. The ability to add technologies and supporting connectors during or after system assembly enables more options, and higher levels of system integration for accommodating new and emerging technologies in existing form factors. As an exemplary embodiment, wireless technologies are easily added to systems using embodiments of the invention. As mentioned, embodiments of the invention also provide greater flexibility for implementing lower cost, better performing, and unique technology solutions, without forcing manufacturers to produce excessive numbers of system designs to accommodate each technology combination separately. The use of modular I/O connectors leverages existing I/O and wireless connectors to enable them to be combined in innovative ways, while still conforming to the system's mechanical and electrical requirements, and without requiring costly system chassis or shield modifications. It also enables new, lower cost radio frequency (RF) connectors to be designed that can help reduce the overall cost of implementing RF, while maintaining the required level of performance. Modular connectors cabled directly to the supported technology device, rather than being connected through motherboard traces, also reduces and/or eliminates the need for using less efficient micro-strip or strip-line transmission solutions on the motherboard for signal transmission lines. And yet further, modular connectors simplify the process of adding technologies so that consumers can add new technologies to already purchased systems with a low risk of system damage, and without a high level of technical skill. Coupling a modular connector into a system also increases the total number of connector ports of a system, increasing in yet another way the technology support capabilities of a system. Therefore, embodiments of the invention provide numerous benefits to system manufacturers and users alike.

The foregoing detailed description and accompanying drawings are only illustrative and not restrictive. They have been provided primarily for a clear and comprehensive understanding of the embodiments of the invention, and no unnecessary limitations are to be understood therefrom. Numerous additions, deletions, and modifications to the embodiments described herein, as well as alternative arrangements, may be devised by those skilled in the art without departing from the spirit of the embodiments and the scope of the appended claims.

1. A modular I/O connector, comprising:
a housing;
at least one cavity in the housing, the cavity having at least one opening to an exterior of the housing;
at least one electrically conductive member within the cavity; and
at least one coupling member to physically couple with a second connector.

2. The modular I/O connector of claim 1, further comprising a shield at least partially enclosing the housing, the shield configured so not to occlude the opening of the cavity.

3. The modular I/O connector of claim 2, wherein the coupling member is an integral part of at least one of the shield and the housing.

4. The modular I/O connector of claim 1, wherein the coupling member is configured to couple with a second coupling member of the second connector.

5. The modular I/O connector of claim 1, further comprising an electrically conductive pathway electrically coupled with the electrically conductive member.

6. The modular I/O connector of claim 5, wherein the conductive pathway is at least one of a captive cable and a detachable cable.

7. The modular I/O connector of claim 1, wherein the cavity is configured to receive at least a portion of a complimentary I/O terminal interconnect member inserted through the opening.

8. The modular I/O connector of claim 1, wherein the electrically conductive member is configured to electrically couple with an electrically conductive contact of a complimentary I/O terminal interconnect member when the complimentary interconnect member is inserted into the cavity through the opening.

9. The modular I/O connector of claim 1, wherein the electrically conductive member is electrically coupled with an electrical contact disposed at a coupling surface of the connector, and the contact is
configured to electrically couple with a second electrical contact of the second connector.

10. A method, comprising:
providing a first connector, comprising:
a housing,
at least one cavity in the housing, the cavity having at least one opening to an exterior of the housing,
at least one electrically conductive member within the cavity, and
at least one coupling member to physically couple the first connecter with a second connector; and
physically coupling the first connector with the second connector.

11. The method of claim 10, wherein, the second connector has an extended shield portion, and at least a portion of the first connector is inserted into the extended shield portion and coupled with at least one of the shield and the housing of the second connector.

12. The method of claim 10, wherein the second connector is coupled a printed circuit board.

13. The method of claim 10, wherein the electrically conductive member is electrically coupled with an electrical contact disposed at a coupling surface of the first connector, the contact being configured to electrically couple with a second electrical contact of the second connector.

14. The method or claim 10, further comprising electrically coupling the first connector with a third connector, a component, or both.

15. The method of claim 10, wherein the coupling member is at least one selected from the group consisting of a projecting member, a receptacle, a channel, an adhesive material, a rotationally interlocking member, a retention assist member, a clip, a threaded fastener, a friction fitting member, and a spring loaded member, or some combination thereof.

16. The method of claim 14, wherein physically and electrically coupling the first connector with the second connector increases the technology support capabilities of a computer system.

17. The method of claim 10, further comprising an electrically conductive pathway electrically coupled with the electrically conductive member

18. A computer system comprising:
a printed circuit board (PCB);
a first connector coupled with the PCB; and
a second connector physically coupled with the first connector, the second connector comprising:
a housing,
at least one cavity in the housing, the cavity having at least one opening to an exterior of the housing,
at least one electrically conductive member within the cavity, and
at least one coupling member to physically couple the second connector with the first connector.

19. The computer system of claim 16, wherein the second connector is electrically coupled with at least one of third connector, a component or both, by an electrically conductive pathway coupled with the electrically conductive member.

20. The computer system of claim 16, wherein the electrically conductive pathway is at least one of a captive cable and a detachable cable.

21. The computer system of claim 16, wherein the cavity of the second connector corresponds with an opening in the system chassis enabling an interconnect member to be inserted into the cavity through the opening.

22. The computer system of claim 17, wherein the second connector increases the number of external connector ports of the system, increases the number of technologies supported by the system, or both.

23. A base connector, comprising:
a housing;
a shield at least partially enclosing the housing; and
at least one coupling member to receive a reciprocal coupling member of a second connector and physically couple the second connector adjacent to a portion of the housing or the shield.

24. The connector of claim 23, wherein the base connector is also configured to physically and electrically couple with a printed circuit board.

25. The connector of claim 23, wherein the shield has an extended portion, and the coupling member is configured to retain at least a portion of the modular connector within the extended portion of the shield.
